(19) United States
(12) Patent Application Publication
(10) Pub. No.: US 2023/0134780 A1
(43) Pub. Date: May 4, 2023

(54) SYSTEM AND METHOD FOR MANUFACTURING A FREEFORM SHAPE FOR AN ELECTRIC AIRCRAFT

(71) Applicant: BETA AIR, LLC, SOUTH BURLINGTON, VT (US)

(72) Inventor: Kyle Werner, SOUTH BURLINGTON, VT (US)

(73) Assignee: BETA AIR, LLC, SOUTH BURLINGTON, VT (US)

(21) Appl. No.: 17/514,981

(22) Filed: Oct. 29, 2021

(51) Int. Cl. B29C 70/22; B32B 27/08; B32B 27/18; B32B 37/00; B32B 37/06; B32B 37/10; B32B 37/18; B32B 38/18; B32B 27/28; B29C 70/44; B29C 33/40; B29C 33/38

(52) U.S. Cl. CPC B29C 70/22; B32B 27/08; B32B 27/18; B32B 37/0046; B32B 37/06; B32B 37/10; B32B 37/185; B32B 38/1833; B32B 27/283; B29C 70/44; B29C 33/40; B29C 33/3842; B32B 2605/18; B32B 2250/24; B32B 2262/106; B32B 2383/00; B29K 2307/04

(57) ABSTRACT

In an aspect, a system for manufacturing a freeform mold for an electric aircraft is presented. The system includes a plurality of polymer sheets. The system includes a conveyor. The conveyor is configured to transport the plurality of polymer sheets from a first location to a second location. The system includes a heating element. The heating element is configured to heat at least a portion of a sheet of the plurality of polymer sheets. The system includes a molding device. The molding device is configured to hold at least a portion of the plurality of polymer sheets in a shape. The system includes a compressing device. The compressing device is configured to apply a pressure to at least a portion of the molding device. The plurality of polymer sheets is molded into a freeform shape by the heating element, molding device, and compressing device.

### FIELD OF THE INVENTION

The present invention generally relates to the field of manufacturing a component for an electric aircraft. In particular, the present invention is directed to a system and method for manufacturing a freeform shape for an electric aircraft.

### BACKGROUND

Electric aircrafts have many different shaped components and parts. Many of these components and parts have irregular shapes and require special manufacturing methods. Current systems and methods of manufacturing electric aircraft components are inefficient and imprecise.

### SUMMARY OF THE DISCLOSURE

In an aspect, a system for manufacturing a freeform mold for an electric aircraft is presented. The system includes a plurality of polymer sheets. The system includes a conveyor. The conveyor is configured to transport the plurality of polymer sheets from a first location to a second location. The system includes a heating element. The heating element is configured to heat at least a portion of a sheet of the plurality of polymer sheets. The system includes a molding device. The molding device is configured to hold at least a portion of the plurality of polymer sheets in a shape. The molding device is further configured to seal at least a portion of the plurality of polymer sheets in the molding device. The system includes a compressing device. The compressing device is configured to apply a pressure to at least a portion of the molding device. The compressing device is further configured to seal the molding device from surrounding air. The compressing device is further configured to inject a gas into at least a portion of the molding device. The plurality of polymer sheets is molded into a freeform shape by the heating element, molding device, and compressing device.

In another aspect, a method of manufacturing a freeform mold for an electric aircraft is presented. The method includes aligning, at a conveyor, a plurality of polymer sheets. The method further includes heating, at the conveyor, at least a portion of a sheet of the plurality of polymer sheets. The method includes sealing, by a sealing device, the plurality of polymer sheets in a molding device. The method further includes compressing, via a compressing device, the molding device to the plurality of polymer sheets. The method includes injecting, via an injecting device, a gas into the molding device wherein the gas expands at least a portion of a sheet of the plurality of polymer sheets. The method further includes releasing the molding device from the conveyor and releasing a freeform shape from the molding device. The freeform shape includes a polymer of the plurality of polymer sheets.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram illustrating an exemplary embodiment of a system for manufacturing a freeform mold for an electric aircraft;

FIG. 2 is an exemplary embodiment of an electric aircraft;

FIG. 3 is an exemplary embodiment of a plurality of polymer sheets;

FIG. 4 is an exemplary embodiment of a molding device;

FIG. 5 is an exemplary embodiment of a compressing device;

FIG. 6 is an exemplary embodiment of a conveyor;

FIG. 7 is a block diagram illustrating a machine learning system;

FIG. 8 is a flowchart of a method for manufacturing a freeform mold for an electric aircraft; and

FIG. 9 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

In the following description, for the purposes of explanation, numerous specific details are set forth in order to provide a thorough understanding of the present invention. It will be apparent, however, that the present invention may be practiced without these specific details. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply embodiments of the inventive concepts defined in the appended claims. Hence, specific dimensions and other physical characteristics relating to the embodiments disclosed herein are not to be considered as limiting, unless the claims expressly state otherwise.

Described herein is a system for manufacturing a freeform mold for an electric aircraft. In some embodiments, the electric aircraft may include an unmanned aerial vehicle (UAV). In some embodiments, the system may include a plurality of polymer sheets. The plurality of polymer sheets may include carbon fiber. The system may include a conveyor. The conveyor may include a belt conveyor. The conveyor may be configured to transport the plurality of polymer sheets from a first location to a second location. The system may include a heating element. The heating element may be configured to heat at least a portion of a sheet of the plurality of polymer sheets. The system may include a molding device. The molding device may include a half mold. The molding device may include a female mold. In some embodiments, the molding device may include an inflatable sheet. The molding device may be configured to hold at least a portion of the plurality of polymer sheets in a shape. The molding device may be configured to seal at least a portion of the plurality of polymer sheets in the molding device. In some embodiments, the molding device may be configured to seal the at least a portion of the plurality of polymer sheets by a sealing component attached to a surface of a female mold. The system may include a compressing device. In some embodiments, the compressing device may be configured to apply a pressure to at least a portion of the molding device for a time threshold. The compressing device may be configured to apply a pressure to at least a portion of the molding device. The compressing device may be configured to seal the molding device from surrounding air. The compressing device may further be configured to inject a gas into at least a portion of the molding device. In some embodiments, the plurality of polymer sheets is molded into a freeform shape by the heating element, molding device, and compressing device. In some embodiments, the freeform shape may include a component of a UAV.

Described herein is a method of manufacturing a freeform mold for an electric aircraft. In some embodiments, the method may include aligning, at a conveyor, a plurality of polymer sheets. The plurality of polymer sheets may include carbon fiber. In some embodiments, the method may include heating, at the conveyor, at least a portion of a sheet of the plurality of polymer sheets. In some embodiments, the method may include sealing, by a sealing device, the plurality of polymer sheets in a molding device. In some embodiments, the sealing device may include a sealing sheet. The sealing sheet may include silicone. In some embodiments, the molding device may include a half mold. In some embodiments, the molding device may include a female mold. In some embodiments, the method may include compressing, via a compressing device, the molding device to the plurality of polymer sheets. In some embodiments, the method may include injecting, via an injecting device, a gas into the molding device. In some embodiments, injecting a gas into the molding device may include injecting gas into an inflatable sheet of the molding device. In some embodiments the gas may expand at least a portion of a sheet of the plurality of polymer sheets. The injecting device may be configured to seal the compressing device and the molding device from surrounding air. In some embodiments, the method may include releasing the molding device from the conveyor. In some embodiments, the method may include releasing a freeform shape from the molding device. In some embodiments, the freeform shape may include a polymer of the plurality of polymer sheets. The freeform shape may include a shape of a flight component of a UAV.

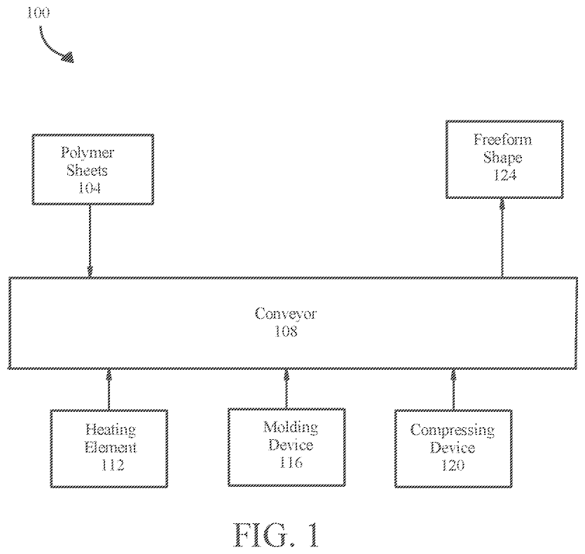

Referring now to the drawings, FIG. 1 illustrates an exemplary embodiment of a block diagram for a system 100 for manufacturing a freeform mold for an electric aircraft. In some embodiments, system 100 may be configured to receive polymer sheets 104. Polymer sheets 104 may include a polymer. A polymer may include, but is not limited to, polyethylene, acrylic, polyester, and the like. In some embodiments, the sheets may include carbon fiber sheets. In some embodiments, polymer sheets 104 may include and/or be impregnated with, layered with, or otherwise combined using an epoxy resin. In an embodiment, one or more elements of polymer sheets 104 may be laminated together using an epoxy, resin, or other joining material that is fluid impermeable. A sheet of polymer material may be sealed to one or more surfaces of polymer sheets 104. Lamination may include pumping epoxy into form, allowing epoxy to permeate between sheets of polymer sheets 104. Lamination may include curing epoxy. Epoxy may cured by waiting for epoxy to solidify, subjecting epoxy to a change of temperature, or the like.

In some embodiments, and with continued reference to FIG. 1, polymer sheets 104 may include a plurality of arrangements. In some embodiments, polymer sheets 104 may include a stacking arrangement. Polymer sheets 104 may be arranged in a stacking arrangement configured to have one sheet perpendicularly aligned to another sheet. In some embodiments, polymer sheets 104 may include a stacking arrangement that may include a 45 degree fiber angle rotation pattern. In a non-limiting example, sheets of polymer sheets 104 may include a 0 degree rotation of a first sheet, a 45 degree rotation of a second sheet, a 90 degree rotation of a third sheet, a 135 degree rotation of a fourth sheet, and a 180 degree rotation of a fifth sheet. In some embodiments, polymer sheets 104 may be aligned manually. In some embodiments, polymer sheets 104 may be aligned automatically. Automatic aligning of polymer sheets 104 may include an electromechanical system. An electromechanical system may be configured to rotate and/or place a sheet of polymer sheets 104 in an arranged stack. In some embodiments, an arranged stack may include an arrangement in which one sheet of polymer sheets 104 may be perpendicular to a sequential sheet of polymer sheets 104. In some embodiments, an electromechanical system may include an artificial intelligence. An artificial intelligence may be configured to align polymer sheets 104 in an arrangement that may maximize a tensile strength of polymer sheets 104. A “tensile strength” as used in this disclosure is the maximum stress that a material can withstand while being stretched or pulled before breaking. The stress is measured as force per unit area, such as pascals (Pa), kilopounds per square inch (ksi), and pounds per square inch (psi). In some embodiments, polymer sheets 104 may include a tensile strength of about 500 ksi.

In some embodiments and with continued reference to FIG. 1, each sheet of polymer sheets 104 may include a plurality of fibers. In some embodiments, the fibers may have a diameter of between 5-10 micrometers. In some embodiments, the fibers may have a diameter of 6 micrometers. Polymer sheets 104 may include between 1-10 sheets. In some embodiments, polymer sheets 104 may include more than 10 sheets. In some embodiments, a sheet of polymer sheets 104 may have a sheet size of 12 inches by 24 inches. In other embodiments, a sheet of polymer sheets 104 may have a sheet size of great or less than 12 inches by 24 inches. In some embodiments, a sheet of polymer sheets 104 may have a thickness of about ⅛ an inch. In other embodiments, a sheet of polymer sheets 104 may have a thickness greater or less than ⅛ an inch.

Still referring to FIG. 1, system 100 may include conveyor 108. Conveyor 108 may be configured to transport one or more objects from one location to another location. In some embodiments, conveyor 108 may be configured to transport one or more objects to one or more locations. Conveyor 108 may include, but is not limited to, a roller bed conveyor, belt conveyor, curved bel conveyor, incline conveyor, decline conveyor, specialty conveyor belt and the like. In some embodiments, the conveyor may include, but is not limited to, a pneumatic, vibrating, flexible, spiral, or vertical conveyor. In some embodiments, conveyor 108 may be configured to transport polymer sheets 104 from a first location to a second location. In some embodiments, conveyor 108 may be configured to transport polymer sheets 104 to a plurality of locations. In some embodiments, conveyor 108 may be configured to transport an object in a straight path. In other embodiments, conveyor 108 may be configured to transport an object along a curved path. In some embodiments, conveyor 108 may be configured to transport an object along a nonsymmetrical path. In some embodiments, conveyor 108 may be configured to transport an object along a symmetrical path. Conveyor 108 may be configured to be in communication with other components of system 100. In some embodiments, conveyor 108 may be in electrical and/or physical communication with heating element 112, molding device 116, and/or compressing device 120. In some embodiments, conveyor 108 may be configured to transport polymer sheets 104 to heating element 112. Conveyor 108 may be configured to transport polymer sheets 104 to molding device 116. Conveyor 108 may be configured to transport polymer sheets 104 and molding device 116 to compressing device 120. In some embodiments, conveyor 108 may be configured to transport molding device 116 and polymer sheets 104 away from compressing device 120. Conveyor 108 may be configured to transport an object along a plurality of paths. In some embodiments, conveyor 108 may be configured to move polymer sheets 104 at a speed of about 1 centimeter a second. In other embodiments, conveyor 108 may be configured to move polymer sheets 104 at a rate greater or less than 1 centimeter a second.

With continued reference to FIG. 1, system 100 may include heating element 112. Heating element 112 may be configured to heat polymer sheets 104. Heating element 112 may be configured to transform an electrical energy into a thermal energy. In some embodiments, heating element 112 may be configured to receive a voltage of between 100-400 volts. In other embodiments, heating element 112 may be configured to receive more than 400 volts. In some embodiments, heating element 112 may be configured to receive less than 100 volts. Heating element 112 may be configured to receive an alternating current (AC) or direct current (DC). In some embodiments, heating element 112 may be configured to include the process of Joule heating that may transform an electrical energy into a thermal one. “Joule heating” as defined in this disclosure is the process by which the passage of an electric current through a conductor produces heat. In some embodiments, heating element 112 may include a resistive wire. The resistive wire may include a metal such as, but not limited to, nichrome, kanthal, cupronickel, and/or etched foil. In some embodiments, heating element 112 may include a semiconductor such as, but not limited to, molybdenum disilicide, silicon carbide, silicon nitride, or other semiconductors, alone or in combination.

Still referring to FIG. 1, in some embodiments heating element 112 may be configured to partially melt polymer sheets 104. In some embodiments, heating element 112 may be configured to soften polymer sheets 104. In some embodiments, heating element 112 may be configured to apply a low heat to polymer sheets 104 for a long period of time. In other embodiments, heating element 112 may be configured to apply a high heat to polymer sheets 104 for a short period of time. In some embodiments, heating element 112 may be configured to heat polymer sheets 104 in any combination of the ways discussed above to aid in binding an epoxy to polymer sheets 104 and/or permit a forming of polymer sheets 104 into a new shape upon cooling. In some embodiments, heating element 112 may be configured to attach to a surface of conveyor 108. In some embodiments, multiple heating elements may be attached to multiple surfaces of conveyor 108. In some embodiments, heating element 112 may include, but is not limited to, a flanged heater, circulation heater, over-the-side heater, screw plug heater, and the like. Heating element 112 may be configured to reach temperatures between 2,000 C to 4,000 C. In other embodiments, heating element 112 may be configured to reach temperatures greater than 4,000 C and/or less than 2,000 C.

In some embodiments, and with continued reference to FIG. 1, system 100 may include molding device 116. Molding device 116 may include a plastic, glass, metal, and/or ceramic material. Molding device 116 may be configured to hold a polymer, polymer sheets, combinations and/or stacks thereof, or the like in a shape. The shape may be circular, rectangular, ovular, square, triangular or other shapes. In some embodiments, the shape may include, but is not limited to, a trapeze, rhombus, kite, pentagon, heptagon, octagon, nonagon, decagon, or other shapes. In some embodiments, the shape may include a cube, cuboid, cone, cylinder, or sphere shape. In some embodiments, the shape may be irregular. In some embodiments, a shape may include any combination of the shapes described above. In some embodiments, molding device 116 may include a shape of a flight component. The flight component may include a flight component of a UAV, such as but not limited to a wing, a tail, a propulsor, a rotor, and the like. In some embodiments, molding device 116 may include a shape of a section of a UAV, such as but not limited to, a hull, a landing gear, an infrastructure, and the like. In some embodiments, molding device 116 may include a shape of an entire UAV. Molding device 116 may include, but is not limited to, a female mold, male mold, half mold, full mold, and the like. In some embodiments, molding device 116 may be configured to include a concave structure. The concave structure may be configured to position polymer sheets 104 in an exterior surface of a shape. In some embodiments, molding device 116 may be configured to include a convex structure. The convex structure may be configured to position polymer sheets 104 in an interior surface of a shape. Molding device 116 may be configured to include a draft angle. A “draft angle” as defined in this disclosure is a slant that is applied to each side of a mold. A draft angle, in an embodiment, may assist with releasing a component that is being molded from a mold. In some embodiments, molding device 116 may include a draft angle of between 1-2 degrees. In other embodiments, molding device 116 may include a draft angle of over 2 degrees. In some embodiments, molding device 116 may include a draft angle of less than 1 degree. The draft angle may include an angle that may be configured to allow a molded polymer to freely release from molding device 116.

In some embodiments and still referring to FIG. 1, molding device 116 may be configured to hold polymer sheets 104 under a pressure for a period of time. A “pressure” as defined in this disclosure is the force applied perpendicular to the surface of an object per unit area over which that force is distributed. The pressure may be measured in pascals, which is defined as one newton per square meter. The pressure may also be measured in the pound-force per square inch (psi). In some embodiments, molding device 116 may include a sealing device. A sealing device may be configured to seal a polymer inside of molding device 116. In some embodiments, the polymer may include polymer sheets 104. The sealing device may prevent contact between polymer sheets 104 and another component of system 100. In some embodiments, the sealing device may prevent direct contact between polymer sheets 104 and compressing device 120. The sealing device may include a sheet. The sheet may include a polymer such as, but not limited to, silicone. In some embodiments, the sealing device may be fixed or otherwise secured to a surface of molding device 116. The sealing device may be configured to be flexible. The sealing device may be configured to stretch or otherwise contort under an applied pressure. In some embodiments, polymer sheets 104 may be compressed by compressing device 120 through the sealing device of molding device 116.

In some embodiments, and still referring to FIG. 1, system 100 may include compressing device 120. Compressing device 120 may include a pneumatic compression device. In some embodiments, compression device 120 may include a hydraulic, air, or other compressor. Compressing device may be configured to apply a pressure to an object. Compressing device 120 may be configured to apply a pressure to molding device 116. In some embodiments, compressing device 120 may be configured to apply a pressure of between 10-100 psi. In other embodiments, compressing device 120 may be configured to apply a pressure of greater than 100 psi. Compressing device 120 may be configured to apply a pressure to molding device 116 for a period of time that allows polymer sheets 104 to take the shape of molding device 116. In some embodiments, compressing device 120 may be configured to include a sealing device. The sealing device may be configured to seal compressing device 120 and molding device 116 from surrounding air. In some embodiments, compressing device 120 may be configured to inject a gas into molding device 116. The injection of gas may be configured to expand polymer sheets 104 to reach more deeply into molding device 116. In some embodiments, compressing device 120 may be configured to inject gas into an inflatable sheet. In some embodiments, compressing device 120 may be configured to inject gas into a balloon. In some embodiments, compressing device 120 may be configured to inject gas into a silicone sheet. The gas may include a carbon mixture. In some embodiments, compressing device 120 may be automated. The automation of compressing device 120 may include an artificial intelligence and/or a machine learning model. Compressing device 120 may be automated to apply a pressure to molding device 116 for a set period of time. In some embodiments, compressing device 120 may be configured to slowly apply an increasing pressure to molding device 116. In other embodiments, compressing device 120 may be automated to apply a constant pressure to molding device 116.

Still referring to FIG. 1, system 100 may be configured to output a freeform shape 124. Freeform shape 124 may include a plurality of shapes. In some embodiments, freeform shape 124 may include a flight component of a UAV. In some embodiments, freeform shape 124 may include a section of a UAV. In other embodiments, freeform shape 124 may include an entire UAV. Freeform shape 124 may include polymer sheets 104. In some embodiments, freeform shape 124 may include the shape of molding device 116. In other embodiments, freeform shape 124 may include a negative of the shape of molding device 116. Freeform shape 124 may include a wing, tail, rotor, propulsor, hull, landing gear, or other component of a UAV.

In some embodiments, and with continued reference to FIG. 1, system 100 may be configured to include an automated process. In an embodiment, an automated manufacturing device, controller, or computing device may identify at least a feature to be formed by comparing a model of discrete object incorporating such features and/or a model of a part or product to be formed from discrete object to a model of discrete object in which such features are excluded. Interrogation may further provide a modification history of discrete object computer model indicating one or more features recently added by a user or automated process.

An automated manufacturing device, controller, or computing device may select a side of a precursor to be presented as a first face of additively manufactured body of material based on detected features; for instance, interrogation may produce data indicating that one or more features to form may be formed by presenting a given side of discrete object and/or precursor as a side of additively manufacture body of material to be machined or otherwise subtractively manufactured. A first side of a precursor may alternatively or additionally be specified by user input. Persons skilled in the art, upon review of the entirety of this disclosure, will be aware of various techniques, APIs, facilities, and/or algorithms for automated determination of orientations for manufacture of a given feature on a given discrete object and/or determination of feasibility of formation of a given feature from a given orientation, for instance using toolpath generation programs, machine-control instruction generation programs, “slicers,” and the like.

Such automation may be implemented using a work cell approach, wherein multiple steps are performed by one or more multitask or a set of single-task work-cell machines and one or more manipulators, as needed, to move a body of material among the work-cell machines. Alternatively, the automation may be implemented using an assembly-line approach, wherein two or more single and/or multitask machines form an assembly line with suitable automated and/or manual conveyance means (e.g., conveyor belts, robots, dollies, push carts, etc.) for moving each body of material from one machine to the next. Some or all of manufacturing steps as described above may be automatedly generated, for instance using a CAM program or the like, based on a graphical model of a precursor, discrete object, additively manufactured body of material, and/or frame. For instance, one or more machine-control instruction sets may be generated from a graphical model of a precursor, discrete object, additively manufactured body of material, and/or frame. Such machine-control instruction sets may be used to control one or more subtractive manufacturing machines to perform one or more manufacturing steps.

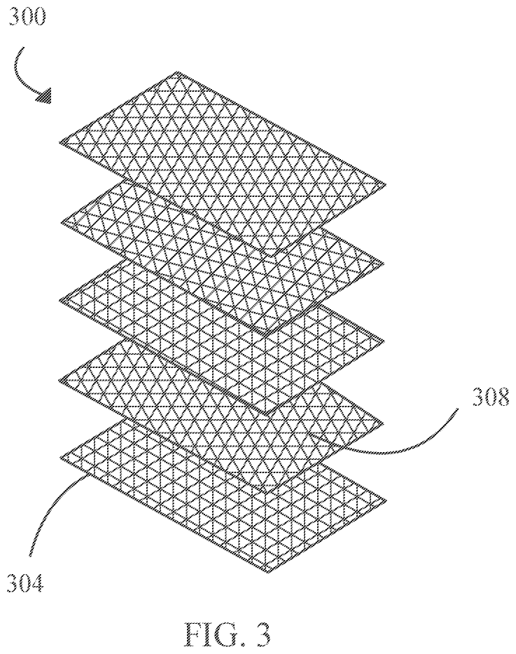

In some embodiments, an automated process may include a machine learning model. A machine learning model is described in detail below with reference to FIG. 3. In some embodiments, a machine learning model may include a set of training data. The training data may include a plurality of mold types of molding device 116. The plurality of mold types may include, but is not limited to, a half mold, a full mold, a female mold, and a male mold. In some embodiments, the plurality of mold types may include a plurality of shapes. The shapes may include UAV components such as, but not limited to, propulsors, rotors, hulls, landing gear, wings, and tails of a UAV. In some embodiments, the shape may include an entire UAV. In some embodiments, the training data may include a material of polymer sheets 104. The material may include a polymer, such as, but not limited to polyethylene, acrylic, polyester, and the like. In some embodiments, the material may include carbon fiber. The training data may include a plurality of types of heating elements 112. In some embodiments, the type of heating element 112 may correlate to a mold shape of molding device 116 and/or a material of polymer sheets 104. The training data may include a plurality of temperatures used to heat polymer sheets 104. In some embodiments, the training data may include a plurality of types of conveyors 108. The plurality of types of conveyors 108 may include, but is not limited to, a roller bed conveyor, belt conveyor, curved bel conveyor, incline conveyor, decline conveyor, specialty conveyor belt and the like. In some embodiments, the training data may include a plurality of compressing devices 120. The plurality of compressing devices may include, but is not limited to, pneumatic, hydraulic, and air compressors. The training data may include a range of pressures used by compressing device 120.

Still referring to FIG. 1, the machine learning model may be configured to optimize a molding process of polymer sheets 104. Optimization may include decreasing a time it takes to output freeform shape 124. In some embodiments, the machine learning model may be configured to optimize a heat being applied by heating element 112 to polymer sheets 104. In some embodiments, the machine learning model may be configured to optimize an operation of conveyor 108. The machine learning model may be configured to reduce a time of transport of polymer sheets 104 from one location to another location by conveyor 108. In some embodiments, the machine learning model may be configured to optimize a pressure applied by compression device 120. In some embodiments, optimization of a pressure applied by compression device 120 may include determining an optimal pressure and time threshold for applying a pressure to molding device 116. The optimal time threshold may include a time molding device 116 may be receiving a pressure from compressing device 120 that may allow polymer sheets 104 to take a shape of molding device 116. In some embodiments, the machine learning model may be configured to optimize an injection of gas into molding device 116. Optimization of an injection of gas into molding device 116 may include determining an optimal gas pressure, gas type, and period of time the gas may be injected into molding device 116.

With continued reference to FIG. 1, the machine learning model of system 100 may be configured to receive a desired shape of polymer sheets 104 and output freeform shape 124 based on, but not limited to, shape type, mold type, material type, time constraints, compressor type, conveyor type, and/or other parameters. In a non-limiting example, the machine learning model may be configured to receive a command to output freeform shape 124 in a shape of a UAV component. The machine learning model may apply parameters to system 100 relating to the UAV component shape. In the non-limiting example, the parameters may include a heating temperature, mold size, mold weight, specific pressure, time under pressure, gas injection time, gas injection pressure, and conveyor speed.

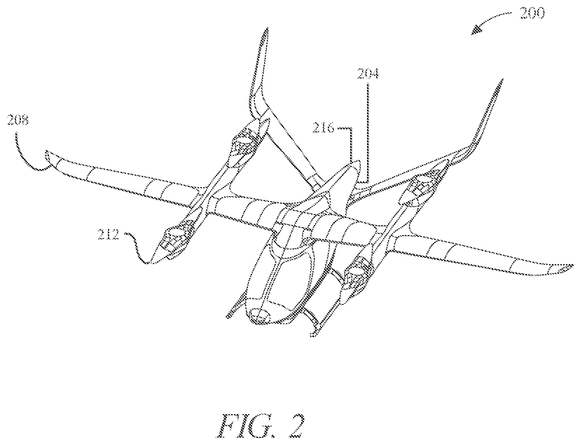

Now referring to FIG. 2, an exemplary embodiment of an electric aircraft is illustrated. Electric aircraft 200 may include an unmanned aerial vehicle (UAV). In some embodiments, the UAV may include a vertical takeoff and landing aircraft (eVTOL). As used herein, a vertical take-off and landing (eVTOL) aircraft is one that may hover, take off, and land vertically. An eVTOL, as used herein, is an electrically powered aircraft typically using an energy source, of a plurality of energy sources to power the aircraft. In order to optimize the power and energy necessary to propel the aircraft. eVTOL may be capable of rotor-based cruising flight, rotor-based takeoff, rotor-based landing, fixed-wing cruising flight, airplane-style takeoff, airplane-style landing, and/or any combination thereof. Rotor-based flight, as described herein, is where the aircraft generated lift and propulsion by way of one or more powered rotors coupled with an engine, such as a “quad copter,” multi-rotor helicopter, or other vehicle that maintains its lift primarily using downward thrusting propulsors. Fixed-wing flight, as described herein, is where the aircraft is capable of flight using wings and/or foils that generate life caused by the aircraft's forward airspeed and the shape of the wings and/or foils, such as airplane-style flight.

With continued reference to FIG. 2, a number of aerodynamic forces may act upon the electric aircraft 200 during flight. Forces acting on an electric aircraft 200 during flight may include, without limitation, thrust, the forward force produced by the rotating element of the electric aircraft 200 and acts parallel to the longitudinal axis. Another force acting upon electric aircraft 200 may be, without limitation, drag, which may be defined as a rearward retarding force which is caused by disruption of airflow by any protruding surface of the electric aircraft 200 such as, without limitation, the wing, rotor, and fuselage. Drag may oppose thrust and acts rearward parallel to the relative wind. A further force acting upon electric aircraft 200 may include, without limitation, weight, which may include a combined load of the electric aircraft 200 itself, crew, baggage, and/or fuel. Weight may pull electric aircraft 200 downward due to the force of gravity. An additional force acting on electric aircraft 200 may include, without limitation, lift, which may act to oppose the downward force of weight and may be produced by the dynamic effect of air acting on the airfoil and/or downward thrust from the propulsor of the electric aircraft. Lift generated by the airfoil may depend on speed of airflow, density of air, total area of an airfoil and/or segment thereof, and/or an angle of attack between air and the airfoil. For example, and without limitation, electric aircraft 200 are designed to be as lightweight as possible. Reducing the weight of the aircraft and designing to reduce the number of components is essential to optimize the weight. To save energy, it may be useful to reduce weight of components of an electric aircraft 200, including without limitation propulsors and/or propulsion assemblies. In an embodiment, the motor may eliminate need for many external structural features that otherwise might be needed to join one component to another component. The motor may also increase energy efficiency by enabling a lower physical propulsor profile, reducing drag and/or wind resistance. This may also increase durability by lessening the extent to which drag and/or wind resistance add to forces acting on electric aircraft 200 and/or propulsors.

Referring still to FIG. 2, Aircraft may include at least a vertical propulsor 204 and at least a forward propulsor 208. A forward propulsor is a propulsor that propels the aircraft in a forward direction. Forward in this context is not an indication of the propulsor position on the aircraft; one or more propulsors mounted on the front, on the wings, at the rear, etc. A vertical propulsor is a propulsor that propels the aircraft in an upward direction; one of more vertical propulsors may be mounted on the front, on the wings, at the rear, and/or any suitable location. A propulsor, as used herein, is a component or device used to propel a craft by exerting force on a fluid medium, which may include a gaseous medium such as air or a liquid medium such as water. At least a vertical propulsor 204 is a propulsor that generates a substantially downward thrust, tending to propel an aircraft in a vertical direction providing thrust for maneuvers such as without limitation, vertical take-off, vertical landing, hovering, and/or rotor-based flight such as “quadcopter” or similar styles of flight.

With continued reference to FIG. 2, at least a forward propulsor 208 as used in this disclosure is a propulsor positioned for propelling an aircraft in a “forward” direction; at least a forward propulsor may include one or more propulsors mounted on the front, on the wings, at the rear, or a combination of any such positions. At least a forward propulsor may propel an aircraft forward for fixed-wing and/or “airplane”-style flight, takeoff, and/or landing, and/or may propel the aircraft forward or backward on the ground. At least a vertical propulsor 204 and at least a forward propulsor 208 includes a thrust element. At least a thrust element may include any device or component that converts the mechanical energy of a motor, for instance in the form of rotational motion of a shaft, into thrust in a fluid medium. At least a thrust element may include, without limitation, a device using moving or rotating foils, including without limitation one or more rotors, an airscrew or propeller, a set of airscrews or propellers such as contrarotating propellers, a moving or flapping wing, or the like. At least a thrust element may include without limitation a marine propeller or screw, an impeller, a turbine, a pump-jet, a paddle or paddle-based device, or the like. As another non-limiting example, at least a thrust element may include an eight-bladed pusher propeller, such as an eight-bladed propeller mounted behind the engine to ensure the drive shaft is in compression. Propulsors may include at least a motor mechanically coupled to the at least a first propulsor as a source of thrust. A motor may include without limitation, any electric motor, where an electric motor is a device that converts electrical energy into mechanical energy, for instance by causing a shaft to rotate. At least a motor may be driven by direct current (DC) electric power; for instance, at least a first motor may include a brushed DC at least a first motor, or the like. At least a first motor may be driven by electric power having varying or reversing voltage levels, such as alternating current (AC) power as produced by an alternating current generator and/or inverter, or otherwise varying power, such as produced by a switching power source. At least a first motor may include, without limitation, brushless DC electric motors, permanent magnet synchronous at least a first motor, switched reluctance motors, or induction motors. In addition to inverter and/or a switching power source, a circuit driving at least a first motor may include electronic speed controllers or other components for regulating motor speed, rotation direction, and/or dynamic braking. Persons skilled in the art, upon reviewing the entirety of this disclosure, will be aware of various devices that may be used as at least a thrust element.

With continued reference to FIG. 2, during flight, a number of forces may act upon the electric aircraft. Forces acting on an aircraft 200 during flight may include thrust, the forward force produced by the rotating element of the aircraft 200 and acts parallel to the longitudinal axis. Drag may be defined as a rearward retarding force which is caused by disruption of airflow by any protruding surface of the aircraft 200 such as, without limitation, the wing, rotor, and fuselage. Drag may oppose thrust and acts rearward parallel to the relative wind. Another force acting on aircraft 200 may include weight, which may include a combined load of the aircraft 200 itself, crew, baggage and fuel. Weight may pull aircraft 200 downward due to the force of gravity. An additional force acting on aircraft 200 may include lift, which may act to oppose the downward force of weight and may be produced by the dynamic effect of air acting on the airfoil and/or downward thrust from at least a propulsor. Lift generated by the airfoil may depends on speed of airflow, density of air, total area of an airfoil and/or segment thereof, and/or an angle of attack between air and the airfoil.

Referring now to FIG. 3, a plurality of polymer sheets 300 is illustrated. In some embodiments, a plurality of polymer sheets 300 may include a polymer sheet 304. Polymer sheet 304 may include a polymer. A polymer may include, but is not limited to, polyethylene, acrylic, polyester, and the like. In some embodiments, polymer sheet 304 may include carbon fiber. In some embodiments, polymer sheet 304 may include and/or be impregnated with, layered with, or otherwise combined using an epoxy resin. In some embodiments, plurality of polymer sheets 300 may include a plurality of arrangements. In some embodiments, plurality of polymer sheets 300 may include a stacking arrangement. Plurality of polymer sheets 300 may be arranged in a stacking arrangement configured to have one polymer sheet 304 perpendicularly aligned to another polymer sheet. In some embodiments, plurality of polymer sheets 304 may include a stacking arrangement that may include a fiber angle rotation pattern 308. In some embodiments, fiber angle rotation pattern 308 may include a 45 degree fiber angle rotation pattern. In a non-limiting example, sheets of plurality of polymer sheets 300 may include a 0 degree rotation of a first sheet, a 45 degree rotation of a second sheet, a 90 degree rotation of a third sheet, a 135 degree rotation of a fourth sheet, and a 180 degree rotation of a fifth sheet.

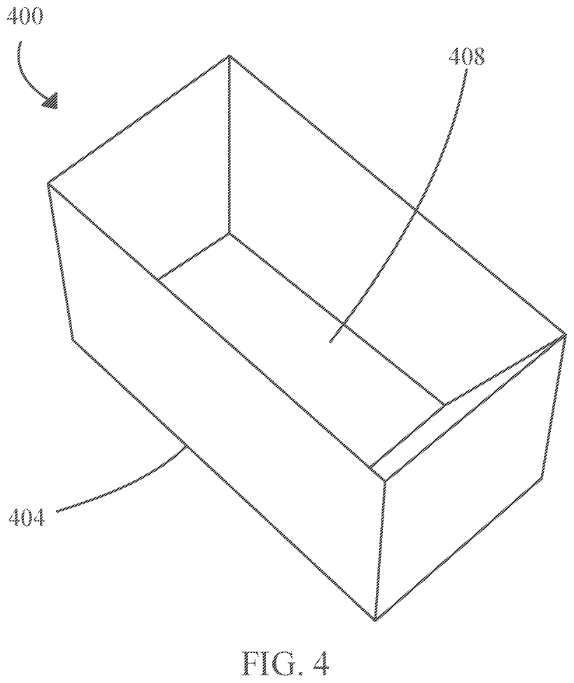

Referring now to FIG. 4, an exemplary embodiment of a molding device 400 is illustrated. In some embodiments, molding device 400 may be configured to include an exterior surface 404. In some embodiments, exterior surface 404 may include, but is not limited to, a plastic, glass, metal, and/or ceramic material. Exterior surface 404 may be configured to hold an interior surface 408. Interior surface 408 may be configured hold a polymer in a shape. Molding device 400 may be configured to hold a polymer, polymer sheets, combinations and/or stacks thereof, or the like in a shape. Interior surface 408 may include a shape. A shape may be circular, rectangular, ovular, square, triangular or other shapes. In some embodiments, a shape may include, but is not limited to, a trapeze, rhombus, kite, pentagon, heptagon, octagon, nonagon, decagon, or other shapes. In some embodiments, a shape may include a cube, cuboid, cone, cylinder, or sphere shape. In some embodiments, a shape may be irregular. In some embodiments, a shape may include any combination of the shapes listed above. In some embodiments, interior surface 408 may include a shape of a flight component. A flight component may include a flight component of a UAV, such as but not limited to a wing, a tail, a propulsor, a rotor, and the like. In some embodiments, interior surface 408 may include a shape of a section of a UAV, such as but not limited to, a hull, a landing gear, an infrastructure, and the like. In some embodiments, interior surface 408 may include a shape of an entire UAV. Interior surface 408 may include, but is not limited to, a female mold, male mold, half mold, full mold, and the like. In some embodiments, interior surface 408 may be configured to include a concave structure. A concave structure may be configured to hold a plurality of polymer sheets in an exterior surface of a shape. In some embodiments, interior surface 408 may be configured to include a convex structure. A convex structure may be configured to position a plurality of polymer sheets in an interior surface of a shape. Molding device 400 may be configured to include a draft angle. A draft angle, in an embodiment, may assist with releasing a component that is being molded from a mold. In some embodiments, molding device 400 may include a draft angle of between 1-2 degrees. In other embodiments, molding device 400 may include a draft angle of over 2 degrees. In some embodiments, molding device 400 may include a draft angle of less than 1 degree. The draft angle may include an angle that may be configured to allow a molded polymer to freely release from molding device 400.

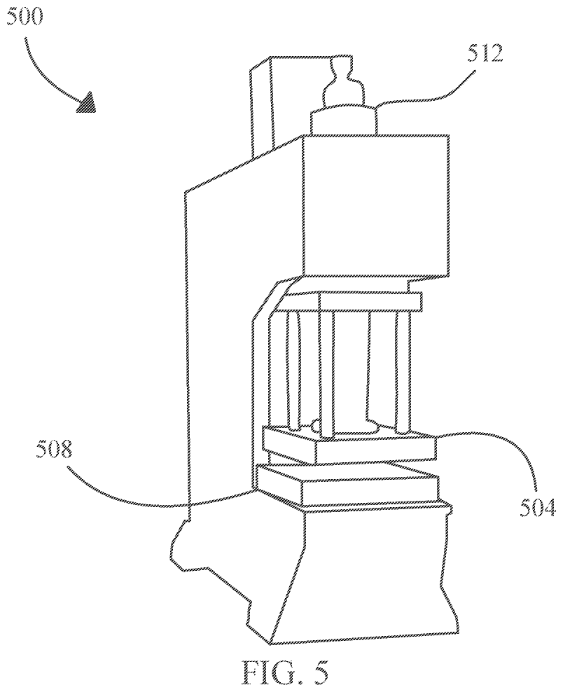

Referring now to FIG. 5, an exemplary embodiment of a compressing device 500 is illustrated. Compressing device 500 may be configured to include a compressing surface 504. Compressing surface 504 may be configured to apply a downwards pressure to an object. In some embodiments, a downwards pressure may be about 500 psi. In other embodiments, a downwards pressure may be greater than 500 psi. In some embodiments, compressing device 500 may be configured to include a receiving surface 508. In some embodiments, receiving surface 508 may be configured to hold a position. In some embodiments, receiving surface 508 may be configured to resist a pressure applied from compressing surface 504. In some embodiments, receiving surface 508 may be configured to hold a molding device in place. In some embodiments, receiving surface 508 may be configured to hold a molding device in place while compressing surface 504 applies a pressure to the molding device. In some embodiments, compressing device 500 may be configured to include a pressure generator 512. Pressure generator 512 may be configured to generate a hydraulic pressure. In some embodiments, a hydraulic pressure may include a pressure generated by a movement of fluids. In some embodiments, pressure generator 512 may be configured to transfer generated pressure to compressing surface 504. Compressing device 500 may include a pneumatic compression device. In some embodiments, compressing device 500 may include a hydraulic, air, or other compressor. Compressing device may be configured to apply a pressure to an object. Compressing device 500 may be configured to apply a pressure to a molding device. In some embodiments, compressing device 500 may be configured to apply a pressure of between 10-100 psi. In other embodiments, compressing device 500 may be configured to apply a pressure of greater than 100 psi. Compressing device 500 may be configured to apply a pressure to a molding device for a period of time that allows a plurality of polymer sheets to take a shape of the molding device. In some embodiments, compressing device 500 may be configured to include a sealing device. The sealing device may be configured to seal compressing device 500 and a molding device from surrounding air. In some embodiments, compressing device 500 may be configured to inject a gas into a molding device. The injection of gas may be configured to expand a plurality of polymer sheets to reach more deeply into a molding device. In some embodiments, compressing device 500 may be configured to inject gas into an inflatable sheet. In some embodiments, compressing device 500 may be configured to inject gas into a balloon. In some embodiments, compressing device 500 may be configured to inject gas into a silicone sheet. A gas may include a carbon mixture. In some embodiments, compressing device 500 may be automated. An automation of compressing device 500 may include an artificial intelligence and/or a machine learning model. Compressing device 500 may be automated to apply a pressure to a molding device for a set period of time. In some embodiments, compressing device 500 may be configured to slowly apply an increasing pressure to a molding device. In other embodiments, compressing device 500 may be automated to apply a constant pressure to a molding device.

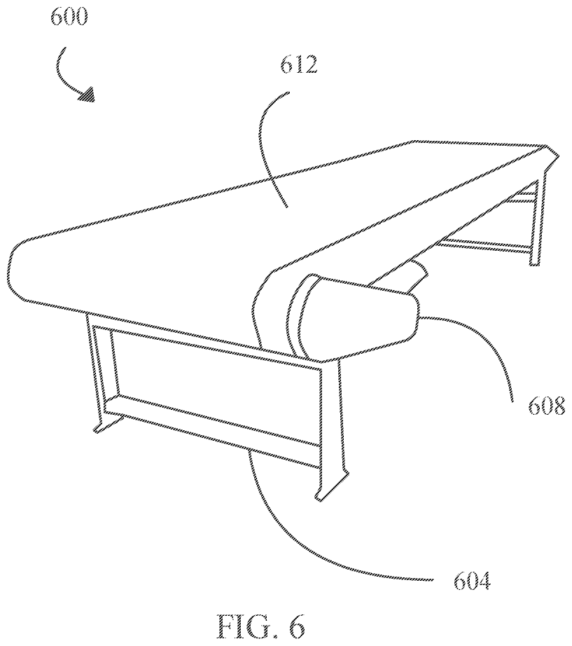

Referring now to FIG. 6, an exemplary embodiment of a conveyor 600 is illustrated. Conveyor 600 may be configured to include supporting structure 604. Supporting structure 604 may be configured to support a weight of a molding device placed on conveyor 600. In some embodiments, supporting structure 604 may include a metal material. In some embodiments, conveyor 600 may be configured to transport one or more objects to one or more locations. Conveyor 108 may include, but is not limited to, a roller bed conveyor, belt conveyor, curved bel conveyor, incline conveyor, decline conveyor, specialty conveyor belt and the like. In some embodiments, the conveyor may include, but is not limited to, a pneumatic, vibrating, flexible, spiral, or vertical conveyor. In some embodiments, conveyor 600 may be configured to transport polymer sheets from a first location to a second location. In some embodiments, conveyor 600 may be configured to transport polymer sheets to a plurality of locations. In some embodiments, conveyor 600 may be configured to transport an object in a straight path. In other embodiments, conveyor 600 may be configured to transport an object along a curved path. In some embodiments, conveyor 600 may be configured to transport an object along a nonsymmetrical path. In some embodiments, conveyor 600 may be configured to transport an object along a symmetrical path. Conveyor 600 may be configured to be in communication with other components of system 100. In some embodiments, conveyor 108 may be in electrical and/or physical communication with heating In some embodiments, conveyor 600 may be configured to include a rotating component 608. Rotating component 608 may include an electric motor. In some embodiments, an electric motor may be configured to generate a torque on a surface of thread 612. In some embodiments, conveyor 600 may be configured to move thread 612 at a speed of about 1 centimeter a second. In other embodiments, conveyor 600 may be configured to move thread 612 at a rate greater or less than 1 centimeter a second.

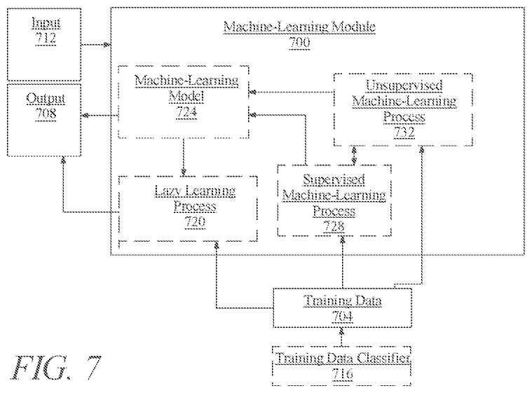

Referring now to FIG. 7, an exemplary embodiment of a machine-learning module 700 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 704 to generate an algorithm that will be performed by a computing device/module to produce outputs 708 given data provided as inputs 712; this is in contrast to a non-machine learning software program where the commands to be executed are determined in advance by a user and written in a programming language.

Still referring to FIG. 7, “training data,” as used herein, is data containing correlations that a machine-learning process may use to model relationships between two or more categories of data elements. For instance, and without limitation, training data 704 may include a plurality of data entries, each entry representing a set of data elements that were recorded, received, and/or generated together; data elements may be correlated by shared existence in a given data entry, by proximity in a given data entry, or the like. Multiple data entries in training data 704 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 704 according to various correlations; correlations may indicate causative and/or predictive links between categories of data elements, which may be modeled as relationships such as mathematical relationships by machine-learning processes as described in further detail below. Training data 704 may be formatted and/or organized by categories of data elements, for instance by associating data elements with one or more descriptors corresponding to categories of data elements. As a non-limiting example, training data 704 may include data entered in standardized forms by persons or processes, such that entry of a given data element in a given field in a form may be mapped to one or more descriptors of categories. Elements in training data 704 may be linked to descriptors of categories by tags, tokens, or other data elements; for instance, and without limitation, training data 704 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 7, training data 704 may include one or more elements that are not categorized; that is, training data 704 may not be formatted or contain descriptors for some elements of data. Machine-learning algorithms and/or other processes may sort training data 704 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 704 to be made applicable for two or more distinct machine-learning algorithms as described in further detail below. Training data 704 used by machine-learning module 700 may correlate any input data as described in this disclosure to any output data as described in this disclosure. As a non-limiting illustrative example flight elements and/or pilot signals may be inputs, wherein an output may be an autonomous function.

Further referring to FIG. 7, training data may be filtered, sorted, and/or selected using one or more supervised and/or unsupervised machine-learning processes and/or models as described in further detail below; such models may include without limitation a training data classifier 716. Training data classifier 716 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 700 may generate a classifier using a classification algorithm, defined as a processes whereby a computing device and/or any module and/or component operating thereon derives a classifier from training data 704. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 716 may classify elements of training data to sub-categories of flight elements such as torques, forces, thrusts, directions, and the like thereof.

Still referring to FIG. 7, machine-learning module 700 may be configured to perform a lazy-learning process 720 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 704. Heuristic may include selecting some number of highest-ranking associations and/or training data 704 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 7, machine-learning processes as described in this disclosure may be used to generate machine-learning models 724. A “machine-learning model,” as used in this disclosure, is a mathematical and/or algorithmic representation of a relationship between inputs and outputs, as generated using any machine-learning process including without limitation any process as described above, and stored in memory; an input is submitted to a machine-learning model 724 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 724 may be generated by creating an artificial neural network, such as a convolutional neural network comprising an input layer of nodes, one or more intermediate layers, and an output layer of nodes. Connections between nodes may be created via the process of “training” the network, in which elements from a training data 704 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 7, machine-learning algorithms may include at least a supervised machine-learning process 728. At least a supervised machine-learning process 728, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include flight elements and/or pilot signals as described above as inputs, autonomous functions as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 704. Persons skilled in the art, upon reviewing the entirety of this disclosure, will be aware of various possible variations of at least a supervised machine-learning process 728 that may be used to determine relation between inputs and outputs. Supervised machine-learning processes may include classification algorithms as defined above.

Further referring to FIG. 7, machine learning processes may include at least an unsupervised machine-learning processes 732. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 7, machine-learning module 700 may be designed and configured to create a machine-learning model 724 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 7, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

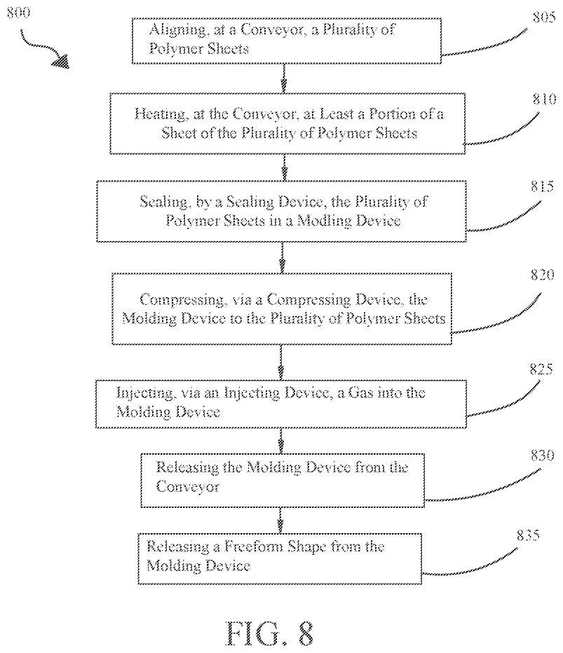

Referring now to FIG. 8, a flowchart for a method 800 of manufacturing a freeform mold for an electric aircraft is illustrated. At step 805, a plurality of polymer sheets are aligned at a conveyor. The polymer sheets may include a polymer. The polymer may include, but is not limited to, polyethylene, acrylic, polyester, and the like. In some embodiments, the polymer may include a carbon fiber. In some embodiments, the polymer sheets may include an epoxy resin. In some embodiments, the polymer sheets may be aligned in a plurality of arrangements. The polymer sheets may be aligned in a stacked arrangement. In some embodiments, the stacked arrangement may include be configured to have one sheet of the polymer sheets perpendicularly aligned to another sheet. In some embodiments, the perpendicular alignment may include every other sheet of the polymer sheets rotated at a 90 degree angle. In some embodiments, the polymer sheets may include a stacking arrangement that may include a 45 degree fiber angle rotation pattern. The polymer sheets may include a 0 degree rotation of a first sheet, a 45 degree rotation of a second sheet, a 90 degree rotation of a third sheet, a 135 degree rotation of a fourth sheet, and a 180 degree rotation of a fifth sheet. In some embodiments, the polymer sheets may be aligned manually. In other embodiments, the polymer sheets may be aligned automatically. The automatic aligning of the polymer sheets may include an electromechanical system. The electromechanical system may be configured to rotate and/or place a sheet of the polymer sheets in an arrangement. In some embodiments, the arrangement may include a stacked arrangement. The stacked arrangement may include an arrangement in which one sheet of polymer sheets may be arranged perpendicularly to a sequential sheet of the polymer sheets. In some embodiments, the electromechanical system may include an artificial intelligence. The artificial intelligence may be configured to align the polymer sheets in an arrangement that may maximize a tensile strength of polymer sheets. In some embodiments, the polymer sheets may include a tensile strength of about 500 ksi.

At step 810, and with continued reference to FIG. 8, at least a portion of a sheet of the plurality of polymer sheets is heated at the conveyor. The at least a portion of a sheet of the plurality of polymer sheets may be heated by a heating element. In some embodiments, there may be multiple heating elements. The heating element may be configured to attach to the conveyor. In some embodiments, multiple heating elements may be attached to the conveyor. In some embodiments, the heating element may be configured to raise the plurality of polymer sheets to a temperature between 2000 C to 5000 C. In some embodiments, the heating element may be configured to raise the temperature of the plurality of polymer sheets above 5000 C. In some embodiments, the heat may be uniformly applied to the plurality of polymer sheets. The heating element may heat a portion of a sheet of the plurality of sheets for a set period of time. In some embodiments, the heating element may be configured to automatically heat the plurality of polymer sheets. In some embodiments, the heating element may be configured to implement artificial intelligence to heat the plurality of polymer sheets. The artificial intelligence may be configured to heat the plurality of polymer sheets such that they soften enough to be molded.

At step 815, and with continued reference to FIG. 8, the plurality of polymer sheets are sealed in a molding device by a sealing device. The molding device may include a female mold. In some embodiments, the molding device may include a male mold. In some embodiments, the molding device may include a half mold. In some embodiments, the molding device may include a full mold. The molding device may include a shape of a flight component of a UAV. The molding device may include a shape of an entire section of a UAV. In some embodiments, the molding device may include a shape of an entire UAV. The molding device may be configured to hold the plurality of polymer sheets in a shape. In some embodiments, the molding device may have a sealing sheet that may cover a surface of a female mold. The sealing sheet may include silicone. In some embodiments, the sealing sheet may be configured to prevent the plurality of polymer sheets from directly touching another component in the system.

At step 820, and with continued reference to FIG. 8, the molding device is compressed to the plurality of polymer sheets via a compressing device. In some embodiments, the compressing device may include a pneumatic compressor. In other embodiments, the compressing device may include a hydraulic, air, or other compressor. The compressing device may be configured to apply a pressure to at least a portion of the molding device. In some embodiments, the compressing device may be configured to apply between 10-50 psi. In some embodiments, the compressing device may be configured to apply a pressure above 50 psi. The compressing device may be configured to apply a pressure to the sealing device of the molding device such that the compressing device avoids direct contact with the plurality of polymer sheets.

At step 825, and with continued reference to FIG. 8, a gas is injected into the molding device via an injecting device. In some embodiments, the compressing device may be configured to include the injecting device. In other embodiments, the injecting device may be a standalone device. The injecting device may be configured to inject a gaseous mixture into the molding device. The gaseous mixture may include a carbon mixture. In some embodiments, the compressing device may be configured to seal the injecting device and molding device from surrounding air. The injecting device may inject the gaseous mixture into the molding device in a sealed environment. In some embodiments, the injecting device may inject the gaseous mixture into the sealing device of the molding device. In some embodiments, the injecting device may inject the gaseous mixture into an inflatable object. The inflatable object may include a balloon-like object. In some embodiments, the expansion of the gas into the molding device may allow the plurality of polymer sheets to expand more deeply across the molding device such that the plurality of polymer sheets may take a shape of the molding device.

At step 830, and with continued reference to FIG. 8, the molding device is released from the conveyor. In some embodiments, the releasing of the molding device from the conveyor may be an automated process. In some embodiments, the automated process may include an artificial intelligence. In other embodiments, the automated process may include a machine learning model. The automated process may be configured to detect a temperature of the molding device such that the plurality of polymer sheets may have hardened and taken the shape of the molding device. In other embodiments, the automated process may be configured to detect a time period that may allow the plurality of polymer sheets to take the shape of the molding device.

At step 835, and with continued reference to FIG. 8, a freeform shape is released from the molding device. The freeform shape comprises a polymer of the plurality of polymer sheets. In some embodiments, the freeform shape may include a flight component. In other embodiments, the freeform shape may include a section of a UAV. In other embodiments, the freeform shape may include an entire UAV. In some embodiments, the freeform shape may include a propulsor, rotator, landing gear, wing, hull, tail, or other component of a UAV.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

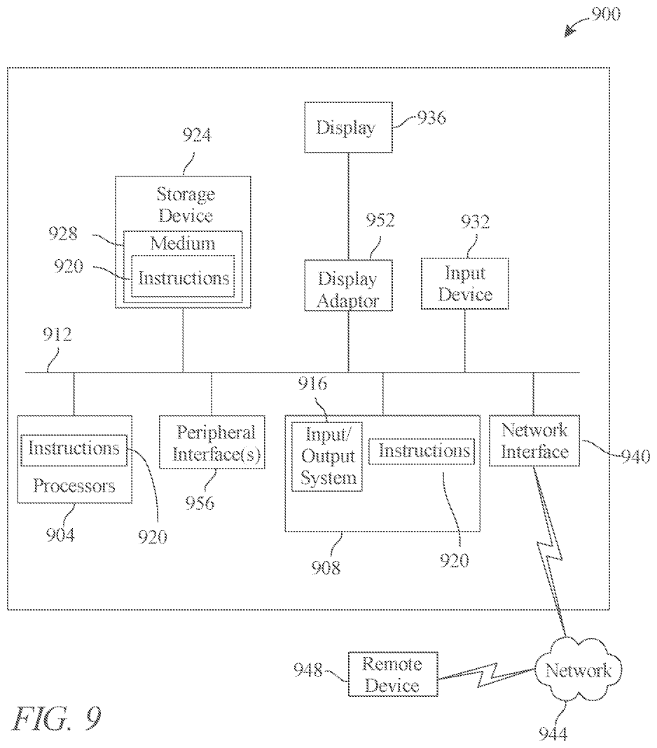

FIG. 9 shows a diagrammatic representation of one embodiment of a computing device in the exemplary form of a computer system 900 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 900 includes a processor 904 and a memory 908 that communicate with each other, and with other components, via a bus 912. Bus 912 may include any of several types of bus structures including, but not limited to, a memory bus, a memory controller, a peripheral bus, a local bus, and any combinations thereof, using any of a variety of bus architectures.

Processor 904 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 904 may be organized according to Von Neumann and/or Harvard architecture as a non-limiting example. Processor 904 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 908 may include various components (e.g., machine-readable media) including, but not limited to, a random-access memory component, a read only component, and any combinations thereof. In one example, a basic input/output system 916 (BIOS), including basic routines that help to transfer information between elements within computer system 900, such as during start-up, may be stored in memory 908. Memory 908 may also include (e.g., stored on one or more machine-readable media) instructions (e.g., software) 920 embodying any one or more of the aspects and/or methodologies of the present disclosure. In another example, memory 908 may further include any number of program modules including, but not limited to, an operating system, one or more application programs, other program modules, program data, and any combinations thereof.

Computer system 900 may also include a storage device 924. Examples of a storage device (e.g., storage device 924) include, but are not limited to, a hard disk drive, a magnetic disk drive, an optical disc drive in combination with an optical medium, a solid-state memory device, and any combinations thereof. Storage device 924 may be connected to bus 912 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 924 (or one or more components thereof) may be removably interfaced with computer system 900 (e.g., via an external port connector (not shown)). Particularly, storage device 924 and an associated machine-readable medium 928 may provide nonvolatile and/or volatile storage of machine-readable instructions, data structures, program modules, and/or other data for computer system 900. In one example, software 920 may reside, completely or partially, within machine-readable medium 928. In another example, software 920 may reside, completely or partially, within processor 904.

Computer system 900 may also include an input device 932. In one example, a user of computer system 900 may enter commands and/or other information into computer system 900 via input device 932. Examples of an input device 932 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 932 may be interfaced to bus 912 via any of a variety of interfaces (not shown) including, but not limited to, a serial interface, a parallel interface, a game port, a USB interface, a FIREWIRE interface, a direct interface to bus 912, and any combinations thereof. Input device 932 may include a touch screen interface that may be a part of or separate from display 936, discussed further below. Input device 932 may be utilized as a user selection device for selecting one or more graphical representations in a graphical interface as described above.

A user may also input commands and/or other information to computer system 900 via storage device 924 (e.g., a removable disk drive, a flash drive, etc.) and/or network interface device 940. A network interface device, such as network interface device 940, may be utilized for connecting computer system 900 to one or more of a variety of networks, such as network 944, and one or more remote devices 948 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 944, may employ a wired and/or a wireless mode of communication. In general, any network topology may be used. Information (e.g., data, software 920, etc.) may be communicated to and/or from computer system 900 via network interface device 940.

Computer system 900 may further include a video display adapter 952 for communicating a displayable image to a display device, such as display device 936. Examples of a display device include, but are not limited to, a liquid crystal display (LCD), a cathode ray tube (CRT), a plasma display, a light emitting diode (LED) display, and any combinations thereof. Display adapter 952 and display device 936 may be utilized in combination with processor 904 to provide graphical representations of aspects of the present disclosure. In addition to a display device, computer system 900 may include one or more other peripheral output devices including, but not limited to, an audio speaker, a printer, and any combinations thereof. Such peripheral output devices may be connected to bus 912 via a peripheral interface 956. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A system for manufacturing a freeform mold for an electric aircraft, the system comprising:
a plurality of polymer sheets;
a conveyor, wherein the conveyor is configured to transport the plurality of polymer sheets from a first location to a second location;
a heating element, wherein the heating element is configured to heat at least a portion of a sheet of the plurality of polymer sheets;
a molding device, wherein the molding device is configured to:
hold at least a portion of the plurality of polymer sheets in a shape; and
seal at least a portion of the plurality of polymer sheets in the molding device;
a compressing device, wherein the compressing device is configured to:
apply a pressure to at least a portion of the molding device;
seal the molding device from surrounding air; and
inject a gas into at least a portion of the molding device;
wherein the plurality of polymer sheets is molded into a freeform shape by the heating element, molding device, and compressing device.

2. The system of claim 1, wherein the electric aircraft is an unmanned aerial vehicle (UAV).

3. The system of claim 1, wherein the plurality of polymer sheets includes carbon fiber.

4. The system of claim 1, wherein the conveyor includes a belt conveyor.

5. The system of claim 1, wherein the molding device includes a half mold.

6. The system of claim 1, wherein the compressing device is further configured to apply a pressure to at least a portion of the molding device for a time threshold.

7. The system of claim 1, wherein the molding device includes a female mold.

8. The system of claim 1, wherein the molding device includes an inflatable sheet.

9. The system of claim 1, wherein the molding device is configured to seal the at least a portion of the plurality of polymer sheets by a sealing component attached to a surface of a female mold.

10. The system of claim 1, wherein the freeform shape includes a component of a UAV.

11. A method of manufacturing a freeform mold for an electric aircraft, the method comprising:
aligning, at a conveyor, a plurality of polymer sheets;
heating, at the conveyor, at least a portion of a sheet of the plurality of polymer sheets;
sealing, by a sealing device, the plurality of polymer sheets in a molding device, compressing, via a compressing device, the molding device to the plurality of polymer sheets;
injecting, via an injecting device, a gas into the molding device, wherein the gas expands at least a portion of a sheet of the plurality of polymer sheets;
releasing the molding device from the conveyor; and
releasing a freeform shape from the molding device, the freeform shape comprising a polymer of the plurality of polymer sheets.

12. The system of claim 11, wherein the electric aircraft is an unmanned aerial vehicle (UAV).

13. The method of claim 11, wherein the molding device includes a half mold.

14. The method of claim 11, wherein the molding device includes a female mold.

15. The method of claim 11, wherein the sealing device includes a sealing sheet.

16. The method of claim 15, wherein the sealing sheet includes silicone.

17. The method of claim 11, wherein injecting a gas into the molding device includes injecting gas into an inflatable sheet of the molding device.

18. The method of claim 11, wherein the polymer of the plurality of polymer sheets includes carbon fiber.

19. The method of claim 11, wherein the injecting device is configured to seal the compressing device and the molding device from surrounding air.

20. The method of claim 11, wherein the freeform shape includes a shape of a flight component of a UAV.
